(19) United States
(12) Patent Application Publication
(10) Pub. No.: US 2025/0280084 A1
(43) Pub. Date: Sep. 4, 2025

(54) IMAGE READER, MULTI-FUNCTION PERIPHERAL, AND METHOD FOR PERFORMING IMAGE READING BY INTERRUPTION DURING ERROR NOTIFICATION

(71) Applicant: BROTHER KOGYO KABUSHIKI KAISHA, Nagoya (JP)

(72) Inventor: Daisuke MATSUMOTO, Nagoya (JP)

(21) Appl. No.: 18/989,275

(22) Filed: Dec. 20, 2024

(30) Foreign Application Priority Data
Feb. 29, 2024 (JP) 2024-029861

(51) Int. Cl. H04N 1/00

(52) U.S. Cl. CPC H04N 1/00824; H04N 1/00076; H04N 1/00915

(57) ABSTRACT

An image reader includes a transparent plate having a placement surface configured to support a read target object placed thereon, a reading unit including a light source configured to emit light toward the transparent plate, and a controller. The controller is configured to perform image reading to cause the reading unit to read the read target object placed on the placement surface of the transparent plate, perform, in response to occurrence of an error, an error notification process to provide a notification that the error has occurred, and perform interrupt processing to interrupt the error notification process and start the image reading in response to receiving a start instruction to start the image reading during the error notification process.

### REFERENCE TO RELATED APPLICATIONS

This application claims priority from Japanese Patent Application No. 2024-029861 filed on Feb. 29, 2024. The entire content of the priority application is incorporated herein by reference.

### BACKGROUND ART

Heretofore, image readers have been known that are configured to optically read an object to be read (hereinafter, which may be referred to as a “read target object”).

An image reader, as an example of the known image readers, includes a reading unit disposed below a transparent plate. The reading unit includes a light source and an image sensor. The image sensor includes a plurality of light receiving elements arranged along a main scanning direction. When light emitted from the light source of the reading unit is reflected by a read target object placed on the transparent plate, and the reflected light is incident on the image sensor of the reading unit, photoelectric conversion is performed by each light receiving element. Thus, a reading operation for a single line along the main scanning direction is achieved by the reading unit. By repeatedly performing the reading operation for a single line along the main scanning direction while moving the reading unit in a sub scanning direction orthogonal to the main scanning direction, the image reader reads the entire read target object, thereby generating image data of the read target object.

Some of the known image readers include a display such as an LCD (“LCD” is an abbreviation for “Liquid Crystal Display”), while others do not include such a display. In the image reader with the reading unit, an error may occur during the execution of a job in which the image reader causes the reading unit to read a read target object and performs arbitrary processing for the read image data of the read target object. For instance, during the execution of a job in which the image reader causes the reading unit to read the read target object and writes the read image data into a USB (“USB” is an abbreviation for “Universal Serial Bus”) memory, an error may occur in which the image reader is unable to write the image data into the USB memory. The image readers with the display may cause the display to display thereon information that an error has occurred, thereby notifying a user that the image reader is in an error state due to the error. However, the image readers without the display are naturally unable to cause the display to display the information that an error has occurred.

Therefore, a technology has been proposed in which, when an image reader without a display is brought into an error state, the image reader notifies a user of the error state by moving a reading unit to a specific position corresponding to the error state and turning on a light source with the reading unit stopped at the specific position.

### SUMMARY

However, in the proposed technology, the reading unit is stopped while the image reader is notifying the user of the error state. Therefore, even if another user attempts to perform a job (such as a job that does not use a USB memory) that should be unrelated to the error that has occurred, the job is unable to be performed until the error state is resolved.

Aspects of the present disclosure are advantageous for providing one or more improved techniques that make it possible to suppress a decrease in productivity of processing (e.g., image reading) even when an image reader causes a reading unit to perform an error notification operation.

According to aspects of the present disclosure, an image reader is provided, which includes a transparent plate, a reading unit, and a controller. The transparent plate has a placement surface configured to support a read target object placed thereon. The reading unit includes a light source configured to emit light toward the transparent plate. The controller is configured to perform image reading to cause the reading unit to read the read target object placed on the placement surface of the transparent plate. The controller is further configured to, in response to occurrence of an error, perform an error notification process to provide a notification that the error has occurred. The controller is further configured to, in response to receiving a start instruction to start the image reading during the error notification process, perform interrupt processing to interrupt the error notification process and start the image reading.

According to aspects of the present disclosure, further provided is a multi-function peripheral that includes an image reader, a printer, and a controller. The printer is configured to print an image on a printing medium. The image reader is configured to read a read target object. The image reader includes a transparent plate having a placement surface configured to support the read target object placed thereon. The image reader further includes a reading unit including a light source configured to emit light toward the transparent plate. The controller is configured to perform an error notification process to cause the reading unit to perform an error notification operation in response to occurrence of an error that stops an operation of the multi-function peripheral. The controller is further configured to perform interrupt processing to start a specific process that is executable regardless of the error in response to receiving a start instruction to start the specific process during the error notification process.

According to aspects of the present disclosure, further provided is a method implementable on a processor of an image reader. The image reader includes a transparent plate and a reading unit. The method includes performing image reading to cause the reading unit to read a read target object placed on a placement surface of the transparent plate. The method further includes performing, in response to occurrence of an error, an error notification process to provide a notification that the error has occurred. The method further includes performing interrupt processing to interrupt the error notification process and start the image reading in response to receiving a start instruction to start the image reading during the error notification process.

### BRIEF DESCRIPTION OF DRAWINGS

FIG. 1 is a perspective view showing a multi-function peripheral (hereinafter referred to as an “MFP”).

FIG. 2 is a cross-sectional view illustrating an internal configuration of an image reader.

FIG. 3 schematically shows a reading unit and a part of a downward-facing surface of a top plate of a housing of the image reader.

FIG. 4 shows examples of a reference position, a standby position, a reading start position, a reading end position, and error notification position(s).

FIG. 5 is a cross-sectional view illustrating an internal configuration of a printer.

FIG. 6 is a block diagram showing an electrical configuration of the MFP.

FIG. 7 is a flowchart showing a procedure of an error notification process.

FIGS. 8A and 8B are flowcharts showing a procedure of a reading start instruction process.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

In the present disclosure, an inclusive OR, meaning that it includes either A or B or both, may be expressed as “A and/or B,” “at least one of A or B,” or “at least one selected from the group consisting of A and B.” The same applies to a case where there are three or more selectable elements to consider.

A detailed explanation will be provided below of an illustrative embodiment according to aspects of the present disclosure with reference to the accompanying drawings.

### Multi-Function Peripheral

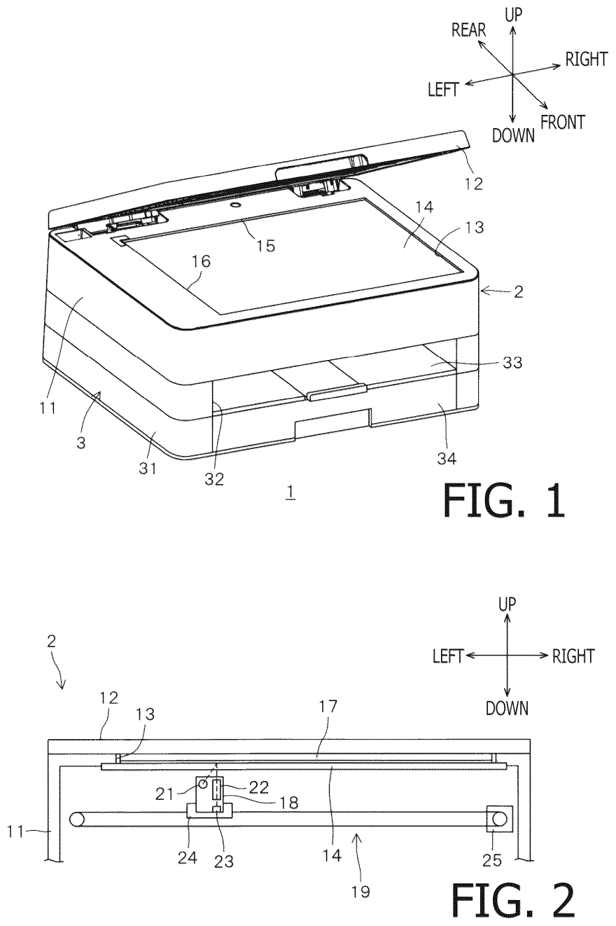

A multi-function peripheral (hereinafter referred to as an “MFP”) 1 shown in FIG. 1 includes an image reader 2 configured to read an object to be read (hereinafter, which may be referred to as a “read target object”), and a printer 3 configured to print an image according to image data on a sheet-like medium. Examples of the read target object may include, but are not limited to, originals such as text or photographs to be read for reproduction by printing, documents to be read for electronic documentation by OCR (“OCR” is an abbreviation for “Optical Character Recognition”) technology, and sheets on which bar codes (one-dimensional bar codes and two-dimensional codes) to be read for decoding are displayed.

In the illustrative embodiment, a frontward direction, a rearward direction, an upward direction, a downward direction, a leftward direction, and a rightward direction of the MFP 1 are defined as shown in FIGS. 1, 2, 3, and 5, and these directions are used as appropriate in the following description.

### Image Reader

As shown in FIGS. 1 and 2, the image reader 2 includes a housing 11 formed substantially in a rectangular shape, and a cover 12 configured to open and close an upper side of the housing 11. A rear end portion of the cover 12 is connected with an upper rear end portion of the housing 11 in such a manner as to be swingable around an axis extending along left-right directions (i.e., the leftward direction and the rightward direction). The cover 12 is configured to swing between an open position and a closed position. Specifically, when the cover 12 is in the open position, a front end of the cover 12 is lifted relative to the upper side of the housing 11 in such a manner as to open the upper side of the housing 11. Meanwhile, when the cover 12 is in the closed position, the cover 12 lies down on the upper side of the housing 11 in such a manner as to cover and close the upper side of the housing 11.

The housing 11 has a rectangular opening 13 formed in an upper surface of the housing 11 to be long in the left-right directions. The opening 13 is closed from below by a transparent plate 14. The transparent plate 14 is made of a transparent plate such as a transparent glass plate or a transparent resin plate.

The read target object is placed at a particular position on the transparent plate 14 with a target surface of the read target object facing downward. The particular position is a position defined based on a left rear corner where a rear edge 15 and a left edge 16 of the opening 13 intersect each other. For instance, when the read target object is formed in a rectangular shape, a corner of the read target object is brought into precise positional adjustment relative to the left rear corner of the opening 13 in such a manner that two edges of the read target object come into contact with the rear edge 15 and the left edge 16 of the opening 13.

As shown in FIG. 2, a background member 17 made of a white resin sheet is elastically supported on an inner surface of the cover 12. The background member 17 is formed substantially in a rectangular shape with a size smaller than the opening 13. When the cover 12 is moved from the open position to the closed position after the read target object is placed on the transparent plate 14, the background member 17 does not ride up on a periphery of the opening 13 of the housing 11, but is placed inside the opening 13 to be spaced apart from each edge of the opening 13, thereby pressing the read target object against the transparent plate 14.

A reading unit 18 and a moving mechanism 19 are disposed below the transparent plate 14.

The reading unit 18 is configured as a CIS (“CIS” is an abbreviation for “Contact Image Sensor”) unit. The reading unit 18 includes a light source 21, a rod lens array 22, and an image sensor 23. The light source 21 includes LEDs (“LED” is an abbreviation for “Light Emitting Diode”) for three colors of R (red), G (green) and B (blue). The rod lens array 22 includes a plurality of rod lenses aligned along a main scanning direction. The main scanning direction is parallel to front-rear directions (i.e., the frontward direction and the rearward direction). Each rod lens is a refractive index distribution lens with upright equal magnification. The image sensor 23 is a linear image sensor including a plurality of light receiving elements arranged at regular intervals of a particular distance along the main scanning direction. For instance, each light receiving element includes color filters and photodiodes for the three colors of R (red), G (green), and B (blue). Each light receiving element is configured to receive light and output an electrical signal (voltage) corresponding to an intensity of each of the RGB color components contained in the received light.

The moving mechanism 19 is configured to move the reading unit 18 along sub scanning directions orthogonal to the main scanning direction. The sub-scanning directions are identical to the left-right directions. The moving mechanism 19 includes a CIS carriage 24 carrying the reading unit 18, and a scanner motor 25 configured to generate a driving force to reciprocate the CIS carriage 24 along the left-right directions.

Example configurations for the image reader 2 are not limited to a configuration in which a CIS system that is an equal magnification optical system is employed as a reading system, but may include a configuration in which a reduction optical system, i.e., a CCD (“CCD” is an abbreviation for “Charge Coupled Devices”) system is employed.

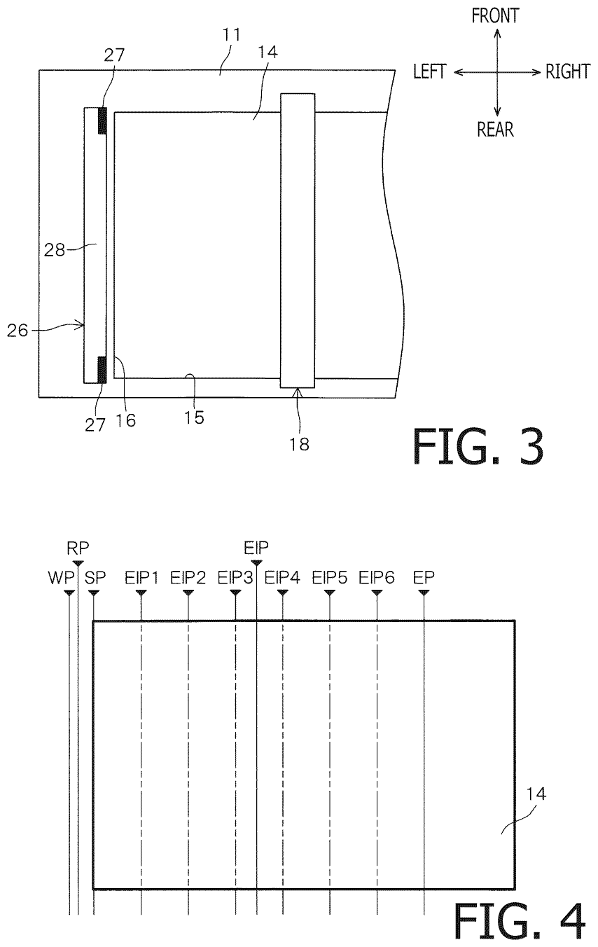

As shown in FIG. 3, a reference member 26 made of a rectangular tape is disposed to the left of the transparent plate 14. The reference member 26 is attached to a downward-facing surface of a top plate of the housing 11 in such a manner as to extend along the front-rear directions on the left side of the transparent plate 14. The reference member 26 includes black areas 27, which are rectangular areas in a front right corner and a rear right corner of the reference member 26, and a white area 28, which is a remaining area other than the black areas 27. As a result, at an end portion along a right edge of the reference member 26, the white area 28 is sandwiched between the two black areas 27 in the front-rear directions, and the black areas 27 and the white area 28 are continuous in the front-rear directions. At each of an end portion along a front edge of the reference member 26 and another end portion along a rear edge of the reference member 26, the white area 28 is adjacent to a left end of the corresponding black area 27, and the corresponding black area 27 and the white area 28 are continuous in the left-right directions.

As shown in FIG. 4, the position of a boundary between a black area 27 and the white area 28, which are continuous in the left-right directions, is a reference position RP. For the image reader 2, specific positions, each of which is a start point or an end point of the movement of the reading unit 18, are set based on the reference position RP. The specific positions, each of which is a start point or an end point of the movement of the reading unit 18, include a standby position WP, a reading start position SP, and a reading end position EP. The standby position WP is a position at which the reading unit 18 is placed when the reading unit 18 is in a standby state in which the reading unit 18 is not in operation. The standby position WP is set spaced leftward from the left edge 16 of the opening 13. The reading start position SP is set spaced leftward from the left edge 16 of the opening 13. The reading end position EP is a position set according to the size of the read target object. The reading end position EP is set spaced rightward from the reading start position SP by a distance according to a length of the read target object in the sub scanning directions.

The standby position WP may be the same as the reference position RP. The reading start position SP may be set spaced rightward from the left edge 16 of the opening 13 by a particular reading margin in order to prevent the reading unit 18 from reading the downward-facing surface of the top plate of the housing 11. A position of the reading unit 18 represents a position of the reading unit 18 when light reflected from the reference member 26, the read target object that is on the transparent plate 14, or the background member 17 is incident on the image sensor 23 of the reading unit 18. For instance, when the light reflected from the read target object that is in the reading end position EP is incident on the image sensor 23, the position of the reading unit 18 coincides with the reading end position EP.

### Printer

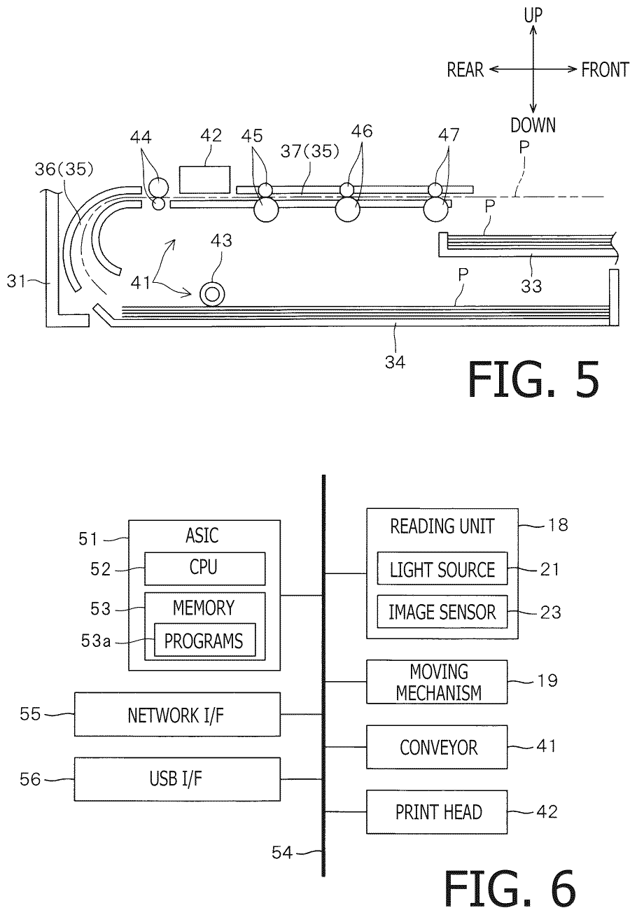

As shown in FIG. 1, the printer 3 includes a housing 31. A rectangular opening 32 is formed in a front surface of the housing 31. The printer 3 further includes a plate-shaped discharge tray 33 in the housing 31. The discharge tray 33 extends along the front-rear directions and the left-right directions to divide a space behind the opening 32 into two sections, i.e., an upper space and a lower space. The printer 3 further includes a feed tray 34 disposed in the lower space below the discharge tray 33. The feed tray 34 is configured to be inserted and removed through the opening 32. The feed tray 34 is formed in a box shape with an open top. For instance, as shown in FIG. 5, printing sheets P are stored in a stacked state on the feed tray 34. The printing sheets P may be an example of “print media” according to aspects of the present disclosure. A printing sheet P with an image printed thereon is discharged into the upper space above the discharge tray 33.

A conveyance path 35 along which the printing sheets P are conveyed is formed in the housing 31. The conveyance path 35 includes a curved path 36 and a straight path 36. The curved path 36 is formed substantially in a semicircular arc shape that curves upward while inflated backward from a rear end of the feed tray 34. The straight path 37 extends straight forward from the curved path 36.

The printer 3 further includes a conveyor 41 and a print head 42 in the housing 31.

The conveyor 41 is configured to convey print media along the conveyance path 35. The conveyor 41 includes a pickup roller 43, first conveyance rollers 44, second conveyance rollers 45, third conveyance rollers 46, and discharge rollers 47. The conveyor 41 further includes a conveyance motor (not shown) configured to provide a driving force to the pickup roller 43, the first conveyance rollers 44, the second conveyance rollers 45, the third conveyance rollers 46, and the discharge rollers 47.

The pickup roller 43 is disposed at such a position that a circumferential surface thereof comes into contact with a topmost one of the printing sheets P in the feed tray 34 when the feed tray 34 is inserted into the lower space below the discharge tray 33. The first conveyance rollers 44 are disposed at a rear end portion of the straight path 37. The second conveyance rollers 45 are spaced forward from the first conveyance rollers 44. The third conveyance rollers 46 are spaced forward from the second conveyance rollers 45. The discharge rollers 47 are spaced forward from the third conveyance rollers 46 and disposed at a front end portion of the straight path 37.

The print head 42 is disposed between the first conveyance rollers 44 and the second conveyance rollers 45 and above the conveyance path 35. A plurality of nozzles are arranged in a lower surface (i.e., a downward-facing surface) of the print head 42. When ink is ejected from the nozzles of the print head 42 with the print head 42 facing a printing sheet P, ink droplets land on the printing sheet P.

The print head 42 may be a line head of which a position is fixed in the main scanning direction, or may be a serial head configured to reciprocate along the main scanning direction, which is parallel to the front-rear directions.

Practicable examples of the printer 3 are not limited to a configuration employing an inkjet method as a printing method, but may include a configuration employing an electrophotographic method or a thermal method.

### Electrical Configuration

As shown in FIG. 6, the MFP 1 includes an ASIC (“ASIC” is an abbreviation for “Application Specific Integrated Circuit”) 51. The ASIC 51 incorporates a CPU (“CPU” is an abbreviation for “Central Processing Unit”) 52 and a memory 53. The memory 53 is a memory unit that includes a non-volatile memory configured to rewrite data, such as a flash memory or an EEPROM (“EEPROM” is an abbreviation for “Electrically Erasable Programmable Read-Only Memory”), and a volatile memory such as a DRAM (“DRAM” is an abbreviation for “Dynamic Random Access Memory”).

The ASIC 51 is connected with a bus 54 for data communication. The bus 54 is connected with the reading unit 18 and the moving mechanism 19 of the image reader 2, and with the conveyor 41 and the print head 42 of the printer 3.

The MFP 1 further includes a network I/F (“I/F” is an abbreviation for “interface”) 55 and a USB I/F 56. The network I/F 55 and the USB I/F 56 are connected with the bus 54.

The network I/F 55 is an interface for data communication with external devices via a network. Examples of the external devices communicable with the MFP 1 via the network I/F 55 may include, but are not limited to, a PC (“PC” is an abbreviation for “Personal Computer”) and an FTP (“FTP” is an abbreviation for “File Transfer Protocol”) server. The data communication method may be a wireless communication method or a wired communication method.

The USB I/F 56 is an interface for data communication with USB devices such as a USB memory. The USB I/F 56 includes a USB connector to which a USB cable is connected, and a USB controller configured to control a USB connection with a USB device.

The CPU 52 of the ASIC 51 is configured to execute programs 53a stored in the non-volatile memory of the memory 53, thereby controlling operations of the image reader 2 (including the reading unit 18 and the moving mechanism 19). The CPU 52 is further configured to execute programs 53a stored in the non-volatile memory of the memory 53, thereby controlling operations of the printer 3 (including the conveyor 41 and the print head 42). When executing those programs 53a, the CPU 52 uses the volatile memory of the memory 53 as a work area.

### Reading Process

In the MFP 1, the CPU 52 performs a reading process to cause the image reader 2 to read the read target object.

In the reading process, the CPU 52 performs a reading operation, in which the CPU 52 turns on the light source 21 of the reading unit 18, and moves the reading unit 18 at a constant speed in one direction (e.g., the rightward direction) of the sub scanning directions, from the reading start position SP to the reading end position EP.

Light emitted from the light source 21 is transmitted through the transparent plate 14 and reflected by the read target object on the transparent plate 14 or by the background member 17, and the reflected light is transmitted through the transparent plate 14 again. When the reflected light passes through the rod lens array 22 to be incident on the image sensor 23, photoelectric conversion is performed at each light receiving element of the image sensor 23. Thereby, a voltage (an electrical signal) corresponding to an amount of light received is output from each light receiving element.

The ASIC 51 includes an A/D conversion circuit. For instance, the A/D conversion circuit has a resolution of 8 bits (256 levels from 0 to 255), and is configured to convert the voltages (the electrical signals) output from the image sensor 23 into pixel values (image data), which are digital values, for each color of RGB. For instance, voltages lower than a lower reference voltage (i.e., a lower limit) are uniformly converted into the pixel value “0.” Voltages higher than an upper reference voltage (i.e., an upper limit) are uniformly converted into the pixel value “255.” Voltages within a range from the lower limit to the upper limit are converted into respective pixel values according to how high each voltage is. When the voltage output from each light receiving element is converted into a corresponding pixel value, reading of a single line in the main scanning direction by the reading unit 18 is accomplished.

In the reading operation, the CPU 52 causes the reading unit 18 to repeatedly perform the single-line reading while moving the reading unit 18 at a constant speed from the reading start position SP to the reading end position EP, thereby reading a reading range between the reading start position SP and the reading end position EP to generate image data of the read target object. The image data of the read target object is corrected using after-mentioned correction data. After completing the reading operation to read the read target object, the image reader 2 reverses the moving direction of the reading unit 18 to perform a return operation of moving the reading unit 18 in the other direction (e.g., the leftward direction) of the sub scanning directions toward the standby position WP.

The reading process includes an operation of sending or storing the image data of the read target object after generating the image data in the reading operation. Examples of the reading process (job) may include, but are not limited to, a reading process “Scan to PC” to send the image data of the read target object to a PC, a reading process “Scan to FTP” to send the image data of the read target object to an FTP server, a reading process “Scan to Email” to send the image data of the read target object as an attachment to an e-mail, and a reading process “Scan to USB” to store the image data of the read target object in a USB memory.

### Printing Process

In the MFP 1, the CPU 52 performs a printing process to cause the printer 3 to print an image according to image data on a print medium. The image data is sent from an external device to the MFP 1 via the network I/F 55 or loaded from a USB memory into the MFP 1 via the USB I/F 56. In response to receiving an instruction to start the printing process when an operable key provided to the external device or the MFP 1 has been operated by the user, the CPU 52 starts a printing operation.

In the printing operation, the pickup roller 43, the first conveyance rollers 44, the second conveyance rollers 45, the third conveyance rollers 46, and the discharge rollers 47 are driven. When the pickup roller 43 rotates with the circumferential surface thereof in contact with the topmost one of the print media (i.e., the printing sheets P) in the feed tray 34, the topmost print medium (i.e., the topmost printing sheet P) is fed into the curved path 36 of the conveyance path 35. Thereafter, the print medium receives a conveyance force from the first conveyance rollers 44, the second conveyance rollers 45, the third conveyance rollers 46 and the discharge rollers 47 in turn, thereby being conveyed toward the discharge tray 33 along the curved path 36 and straight path 37 of the conveyance path 35.

The printer 3 causes the print head 42 to selectively eject ink from the nozzles while conveying the print medium along the straight path 37, thereby forming an image with ink droplets landing on the print medium. Thus, the image according to the image data is printed on the print medium by the time the print medium completely passes the position facing the print head 42. When the print medium with the image formed thereon according to the image data has finished passing between the discharge rollers 47, the print medium is discharged into a space above the discharge tray 33 and then received by the discharge tray 33.

### Error Notification Process

In the MFP 1, an error may occur that prevents the reading process or the printing process from being completed.

Examples of errors that prevent the reading process from being completed may include, but are not limited to, an error due to a failure of the reading unit 18 such as a failure of the image sensor 23 to perform photoelectric conversion, or a failure of the light source 21 to be turned on. Examples of errors that prevent the reading process from being completed may further include, but are not limited to, such an error that the image data is unable to be written into a USB memory because the capacity of the USB memory becomes full during the reading process “Scan to USB.” Examples of errors that prevent the reading process from being completed may further include, but are not limited to, such an error that the image data is unable to be sent from the MFP 1 to a PC because the network connection of the MFP 1 or the PC is disconnected during the reading process “Scan to PC.”

Examples of errors that prevent the printing process from being completed may include, but are not limited to, an error due to a failure of the conveyor 41, an error due to a failure of the print head 42 such as a failure of the print head 42 to eject ink, and an error due to a sheet shortage in which there are no printing sheets P in the feed tray 34. Examples of errors that prevent the printing process from being completed may further include, but are not limited to, an error in which the printer 2 is unable to convey a printing sheet P due to a paper jam in which the printing sheet P is stuck on the conveyance path 35 during the printing process.

It is noted that, in the illustrative embodiment, “errors” that prevent the printing process from being completed do not include an error in which the reading unit 18 is unable to move due to a failure of the moving mechanism 19.

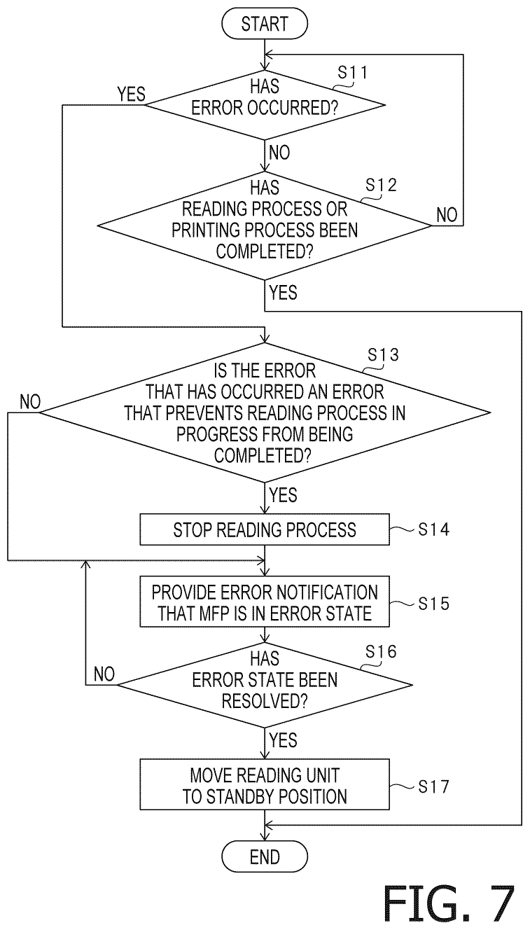

To notify the user that the MFP 1 is in an error state, the CPU 52 performs an error notification process shown in FIG. 7. The error notification process is triggered, for instance, by an instruction to start the reading process or the printing process. When attempting to start the reading process, the user places the read target object at a specified position on the transparent plate 14. The user then operates an operable key provided to an external device or the MFP 1, thereby providing an instruction to start the reading process.

In the error notification process, the CPU 52 determines whether an error has occurred in the MFP 1 (S11).

When no error has occurred in the MFP 1, the CPU 52 determines that no error has occurred (S11: NO). In this case, the CPU 52 determines whether the reading process or the printing process in progress has been completed (S12). In response to determining that the reading process or the printing process in progress has been completed (S12: YES), the CPU 52 terminates the error notification process. In response to determining that the reading process or the printing process in progress has not been completed (S12: NO), the CPU 52 again determines whether an error has occurred in the MFP 1 (S11). Thus, if a no-error state persists in which no error has occurred, the CPU 52 repeatedly determines whether an error has occurred in the MFP 1, until the reading process or the printing process in progress is completed.

When an error has occurred in the MFP 1, the CPU 52 determines that an error has occurred (S11: YES). In this case, the CPU 52 determines whether the error that has occurred is an error that prevents the reading process in progress from being completed (S13).

In response to determining that the error that has occurred is an error that prevents the reading process in progress from being completed (S13: YES), the CPU 52 stops the reading process (S14). Suppose for instance that an error due to a failure of the image sensor 23 has occurred during a reading operation to read the read target object. In this case, the CPU 52 determines that the error due to the failure of the image sensor 23 is an error that prevents the reading process from being completed because the CPU 52 is unable to continue the reading operation. The CPU 52 then stops the reading operation in the reading process. Furthermore, suppose for instance that in the reading process “Scan to USB,” an error has occurred in which the image data is unable to be written into a USB memory because the capacity of the USB memory becomes full during a data saving operation to save the image data in the USB memory after the reading operation is completed. In this case, the CPU 52 stops the data saving operation in the reading process since the CPU 52 is unable to continue the data saving operation. The CPU 52 then causes the reading unit 18 of the image reader 2 to perform an error notification operation, thereby providing a notification that the MFP 1 (the image reader 2) is in an error state (S15).

On the other hand, in response to determining that the error that has occurred during the reading process is not an error that prevents the reading process in progress from being completed (S13: NO), the CPU 52 does not stop the reading process (i.e., the CPU 52 skips S14), and causes the reading unit 18 to perform the error notification operation after the reading process is completed, thereby providing a notification that the MFP 1 is in an error state (S15). The error, which is not an error that prevents the reading process from being completed, means an error that allows the reading process to be completed and does not prevent the reading process from being completed. For instance, an error due to a paper jam caused in the printer 3 does not prevent the reading process from being completed, and therefore is determined not to be an error that prevents the reading process from being completed.

In addition, for instance, when an error due to a paper jam has occurred not during the reading process but during the printing process, the error does not prevent the reading process from being completed because the reading process is not being executed. Therefore, in such a case, the CPU 52 determines that the error that has occurred in the MFP 1 is not an error that prevents the reading process from being completed (S13; NO), and causes the reading unit 18 to perform the error notification operation, thereby providing a notification that the MFP 1 is in an error state (S15).

In response to determining that an error has occurred while the reading unit 18 is stopped at the standby position WP, the CPU 52 causes, in the error notification operation, the reading unit 18 to move from the standby position WP to an error notification position EIP and stop. As shown in FIG. 4, the error notification position EIP is to the right of the reading start position SP, and is a position where the reading unit 18 is within a range of the opening 13 in the left-right directions. In other words, the error notification position EIP is a position where the reading unit 18 is opposed to the transparent plate 14 in a light emission direction in which light is emitted from the light source 21, and is visually recognizable by the user through the transparent plate 14. Further, in response to determining that an error has occurred while the reading unit 18 is moving, the CPU 52 causes, in the error notification operation, the reading unit 18 to stop once, then move from the stopped position to the error notification position EIP, and stop.

The error notification position EIP may be set to a fixed position regardless of what type of error has occurred, or may be set to different positions in the sub scanning directions depending on what type of error has occurred. For instance, as indicated by double-dash chain lines in FIG. 4, error notification positions EIP1, EIP2, EIP3, EIP4, EIP5, and EIP6 may be set to the right of the reading start position SP. In this case, for instance, the error notification position EIP1 may be associated with an error due to a failure of the reading unit 18. The error notification position EIP2 may be associated with an error that the image data is unable to be written into a USB memory. The error notification position EIP3 may be associated with an error that the image data is unable to be sent to an external device. The error notification position EIP4 may be associated with an error due to a failure of the print head 42. The error notification position EIP5 may be associated with an out-of-paper error. The error notification position EIP6 may be associated with an error due to a paper jam in which a printing sheet P is stuck.

After providing the notification that the MFP 1 is in the error state, the CPU 52 determines whether the error state has been resolved (S16). In response to determining that the error state has not been resolved (S16: NO), the CPU 52 continues to provide the notification that the MFP 1 is in the error state through the error notification operation (S15). Thus, during the error notification operation to provide the notification that the MFP 1 is in the error state, the CPU 52 repeatedly determines whether the error state has been resolved.

When the error state has been resolved by the user's action on the error, the CPU 52 determines that the error state has been resolved (S16: YES). The CPU 52 then moves the reading unit 18 from the error notification position EIP to the standby position WP (S17). Thereafter, the CPU 52 terminates the error notification process.

### Reading Start Instruction Process

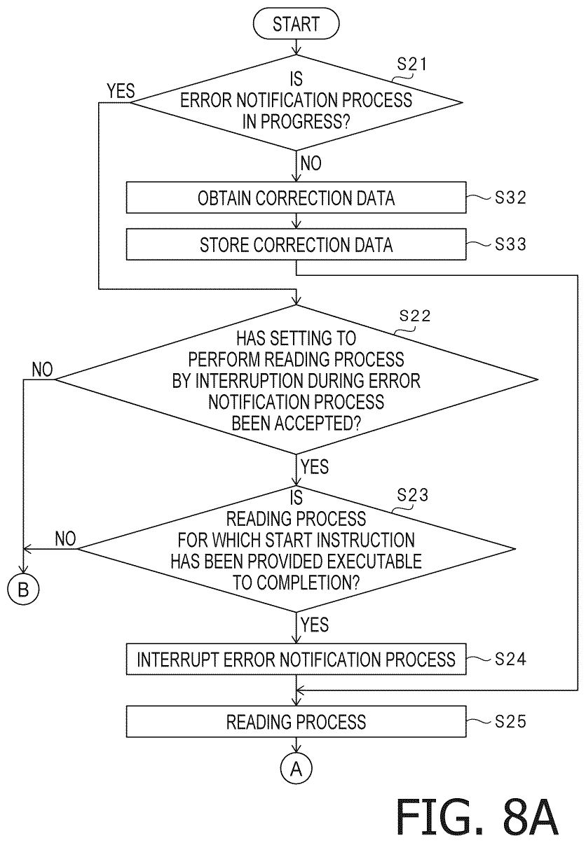

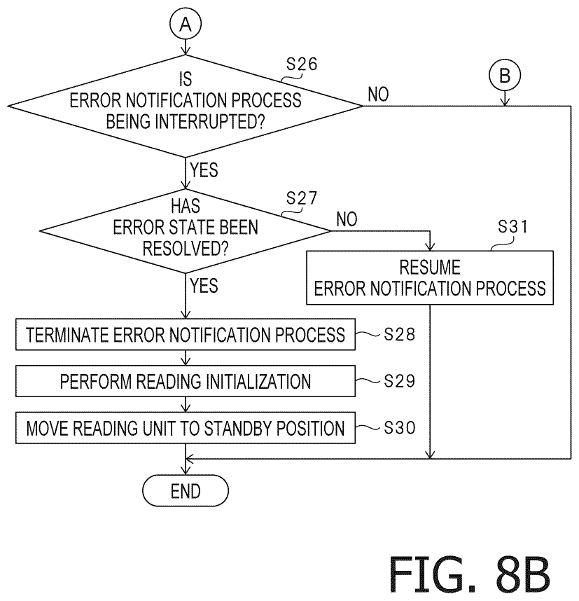

In response to receiving an instruction to start the reading process, the CPU 52 performs a reading start instruction process shown in FIGS. 8A and 8B.

As shown in FIG. 8A, in the reading start instruction process, the CPU 52 determines whether the error notification process is in progress (S21).

In response to determining that the error notification process is not in progress (S21: NO), the CPU 52 obtains correction data for correcting the image data of the read target object, prior to starting the reading process (S32). The CPU 52 then stores the correction data in the memory 53 (S33). The correction data stored in the memory 53 is updated to be overwritten each time new correction data is obtained.

Specifically, the CPU 52 causes the reading unit 18 to read a white area 28 of the reference member 26. The CPU 52 then obtains a white level correction value for correcting non-uniformity of a white level from pixel values of a single line obtained by reading the white area 28, and uses the obtained white level correction value as correction data for shading correction (S32). The CPU 52 then stores the correction data for shading correction in the memory 53 (S33).

The CPU 52 may adjust a light intensity of the light from the light source 21 of the reading unit 18 in such a manner that a maximum value, among the pixel values of individual pixels of a single line obtained by causing the reading unit 18 to read the white area 28 of the reference member 26, is a particular value (e.g., 255). The light intensity of the light from the light source 21 is adjusted by a current value supplied to the light source 21 and a duty ratio of an illumination time during which the light source 21 is turned on within one cycle. In this case, when the light intensity has been adjusted, the CPU 52 obtains the adjusted current value and the adjusted duty ratio as correction data for light intensity adjustment (S32), and stores the obtained correction data for light intensity adjustment in the memory 53 (S33).

When the current value supplied to the light source 21 and the duty ratio of the illumination time during which the light source 21 is turned on within one cycle are adjusted based on the correction data for light intensity adjustment stored in the memory 53, the image data of the read target object as obtained in the reading process is substantially corrected. It is preferred that the correction data for shading correction be obtained after the light intensity of the light from the light source 21 is adjusted.

After storing the correction data for light intensity adjustment in the memory 53, the CPU 52 starts the reading process (S25). The details of the reading process are as described above.

When the reading process has been completed, the CPU 52 determines whether the error notification process is being interrupted (S26), as shown in FIG. 8B. In response to determining that the error notification process is not being interrupted (S26: NO), the CPU 52 terminates the reading start instruction process.

The MFP 1 is configured to accept a setting, input from an external device, as to whether to perform a reading process by interruption during the error notification process. For instance, the setting may be input from the external device each time an instruction to start a reading process is provided. In another instance, the setting may be maintained, after being accepted once by the MFP 1, until a change in the setting is input from the external device.

When the reading start instruction process is started in response to an instruction (hereinafter, which may be referred to as a “start instruction”) to start a reading process being provided during the error notification process, the CPU 52 determines that the error notification process is in progress (S21: YES), as shown in FIG. 8A, and determines whether the setting to perform a reading process by interruption during the error notification process has been accepted (S22).

In response to determining that the setting to perform a reading process by interruption during the error notification process has been accepted (S22: YES), the CPU 52 determines whether the reading process for which the start instruction has been provided is executable to completion regardless of the error state of the MFP 1 (S23). Suppose for instance that an error in which the image data is unable to be written into a USB memory has occurred during the reading process “Scan to USB.” In this case, if a start instruction to start the reading process “Scan to PC” is newly provided, the reading process “Scan to PC” for which the start instruction is newly provided is executable to completion regardless of the error state. This is because the reading process “Scan to PC” does not include a process of writing the image data into the USB memory. Furthermore, for instance, in the case where an error has occurred in the printer 3, any type of reading process for which a start instruction has been newly provided is executable to completion regardless of the error state.

In response to determining that the reading process for which the start instruction has been provided is executable to completion regardless of the error state of the MFP 1 (S23: YES), the CPU 52 interrupts the error notification process (S24) and performs interrupt processing, thereby moving the reading unit 18 that is stopped at the error notification position EIP to the reading start position SP without returning the reading unit 18 to the standby position WP. Then, the CPU 52 starts a reading operation in the reading process (S25) and moves the reading unit 18 at a constant speed from the reading start position SP to the reading end position EP. The CPU 52 does not obtain the correction data, but corrects the image data of the read target object using the correction data stored in the memory 53. The reading process is complete when the reading operation, the return operation of moving the reading unit 18 to the reading start position SP, and an operation of sending or storing the image data are completed.

After the reading process is completed, the CPU 52 determines whether the error notification process is being interrupted (S26), as shown in FIG. 8B. In response to determining that the error notification process is being interrupted (S26: YES), the CPU 52 determines whether the error state has been resolved (S27).

When the error state has been resolved by the user's action on the error while the error notification process is being interrupted, the CPU 52 determines that the error state has been resolved (S27: YES). In this case, there is no need to provide a notification of the error condition. Therefore, the CPU 52 terminates the error notification process being interrupted (S28). At this time, the reading unit 18 is located at the standby position WP.

After the error notification process is completed, the CPU 52 performs reading initialization to reset the start position or the end position of the movement of the reading unit 18 based on the reference position RP (S29). Namely, the CPU 52 causes the reading unit 18 to read the reference member 26. Then, from the image data generated by reading the reference member 26, the CPU 52 searches for a particular position where the pixel value changes from one value to another across a black-white determination threshold between mutually adjacent pixels in the sub scanning directions. When the particular position is found, the CPU 52 determines the particular position as the reference position RP. The CPU 52 resets the standby position WP and the reading start position SP based on the reference position RP.

Thereafter, the CPU 52 moves the reading unit 18 to the standby position WP (S30), and terminates the reading start instruction process.

On the other hand, in response to determining that the error state has not been resolved (S27: NO), the CPU 52 resumes the error notification process under interruption (S31). When the error notification process has been resumed, the CPU 52 causes the reading unit 18 to perform the error notification operation in which the reading unit 18 moves from the standby position WP to the error notification position EIP, thereby providing a notification that the MFP 1 is in the error state (S14 in FIG. 7).

Suppose that the CPU 52 has started the reading start instruction process in response to receiving a start instruction to start the reading process during the error notification process when the setting to not perform the reading process by interruption during the error notification process has been accepted by the MFP 1. In this case, the CPU 52 determines that the setting to perform the reading process by interruption during the error notification process has not been accepted (S22: NO in FIG. 8A), and terminates the reading start instruction process.

Further, in response to determining that the setting to perform the reading process by interruption during the error notification process has been accepted (S22: YES in FIG. 8A) and that the reading process for which the start instruction has been provided is not executable to completion (S23: NO in FIG. 7A), the CPU 52 terminates the reading start instruction process.

### Operations and Advantageous Effects

According to the configuration described above, when an error has occurred in the MFP 1, the CPU 52 performs the error notification process, in which the CPU 52 causes the reading unit 18 to perform the error notification operation. When an error that prevents the reading process from being completed has occurred during the reading process, the CPU 52 stops the reading process and causes the reading unit 18 to perform the error notification operation. In the error notification operation, the reading unit 18 moves to the error notification position EIP and stops. Thus, it is possible to provide a notification that the MFP 1 is in an error state.

In the case where a start instruction to start the reading process has been provided during the error notification process (more specifically, while the notification that the MFP 1 is in an error state is being provided), if the reading process for which the start instruction has been provided is executable to completion regardless of the error state of the MFP 1, the error notification process is interrupted, and the reading process is started. Thus, it is possible to start the reading process even though the error state has not been resolved.

Further, as described above, the error notification position EIP may be set to different positions (e.g., the error notification positions EIP1 to EIP6 in FIG. 4) in the sub scanning directions depending on what type of error has occurred. In such a configuration, the reading unit 18 may be controlled to stop at a corresponding one of the different error notification positions EIP1 to EIP6 depending on the type of the error that has occurred. Thus, it is possible to notify the user of the type of the error that has occurred, in addition to the fact that the MFP 1 is in an error state.

When the error notification process is interrupted, and the reading process is started, the reading unit 18 moves to the reading start position SP without returning to the standby position WP from the error notification position EIP. Thus, it is possible to start the reading process promptly.

In the image reader 2, the reference member 26 is disposed at the reference position RP, and the reference member 26 is read by the reading unit 18 in response to a start instruction to start the reading process while the error notification process is not in progress. Then, using the image data of the reference member 26, the correction data for correcting the image data of the read target object in the reading process, is obtained and stored in the memory 53. By correcting the image data of the read target object using the correction data stored in the memory 53, it is possible to obtain high-quality image data from which influences of uneven densities among the pixels due to the characteristics of the optical system are eliminated.

When the reading process that was started with the error notification process interrupted is completed, the CPU 52 determines whether the error state has been resolved. In response to determining that the error state has not been resolved, the CPU 52 resumes the error notification process. When the error notification process is resumed, the CPU 52 causes the reading unit 18 to perform the error notification operation. Therefore, it is possible to again notify the user that the MFP 1 is in the error state.

The reading process to be started after the error notification process is interrupted is a reading process that is executable to completion regardless of the error state of the MFP 1. Thus, it is possible to prevent a reading process that is not executable to completion depending on the error state of the MFP 1 from being started, thereby preventing occurrence of multiple errors.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential alternatives, modifications, or variations according to aspects of the present disclosure are provided below.

In the aforementioned illustrative embodiment, in the error notification operation, the reading unit 18 moves to the error notification position EIP and stops there. However, for instance, in response to determining that an error has occurred in the MFP 1 with the reading unit 18 stopped at the standby position WP, the CPU 52 may turn on the light source 21 in that state. Further, for instance, in response to determining that an error has occurred in the MFP 1 while the reading unit 18 is moving, the CPU 52 may stop the reading unit 18 and turn on the light source 21 in that state.

In the aforementioned illustrative embodiment, the error notification position EIP may be set to different positions (e.g., the error notification positions EIP1 to EIP6 in FIG. 4) in the sub scanning directions depending on what type of error has occurred. However, for instance, the error notification position EIP may be set to a single position. In this case, in the error notification operation, the reading unit 18 may be controlled to stop at the error notification position EIP, and the light source 21 of the reading unit 18 may be controlled to emit light in different modes (e.g., to emit light of different colors, to emit light in different blinking patterns, or to emit light of different colors in different blinking patterns) depending on what type of error has occurred.

In the aforementioned illustrative embodiment, “errors” that prevent the printing process from being completed do not include an error in which the reading unit 18 is unable to move due to a failure of the moving mechanism 19. However, for instance, when the error has occurred in which the reading unit 18 is unable to move due to a failure of the moving mechanism 19, the reading unit 18 may be controlled to emit light in a specific mode (e.g., to emit light of a specific color, to emit light in a specific blinking pattern, or to emit light of a specific color in a specific blinking pattern) indicating the error, at a position where the reading unit 18 has stopped since the reading unit 18 is unable to move.

The image reader 2 may include an ADF (“ADF” is an abbreviation for “Automatic Document Feeder”), and may employ, as a reading method therefor, an ADF method for reading the read target object while conveying the read target object by the ADF, in addition to an FB (“FB” is an abbreviation for “Flat Bed”) method for reading the read target object placed on the transparent board 14. The image reader 2 may employ the ADF method as a reading method and may not employ the FB method. In a configuration in which the FB method is not employed, the reading unit 18 is located at a fixed position. Therefore, in such a configuration, the light source 21 of the reading unit 18 may be turned on at the fixed position in the error notification operation.

In the aforementioned illustrative embodiment, when a reading process for which a start instruction has been provided during the error notification process is executable to completion, the CPU 52 interrupts the error notification process and performs the interrupt processing. However, the error may be resolved during the interrupt processing. Therefore, even when the reading process for which the start instruction has been provided during the error notification process is not executable to completion, the CPU 52 may interrupt the error notification process and perform the interrupt processing.

In the interrupt processing, the reading unit 18 that is stopped at the error notification position EIP may be temporarily returned to the standby position WP and moved from the standby position WP to the reading start position SP.

Furthermore, the CPU 52 may not resume the error notification process if the error state has not been resolved after completion of the reading process performed by the interrupt processing during the error notification process.

In the aforementioned illustrative embodiment, the MFP 1 is configured to accept a setting as to whether to perform a reading process by interruption during the error notification process. However, the MFP 1 may be configured to not accept a setting as to whether to perform a reading process by interruption during the error notification process. In this case, the CPU 52 may perform the interrupt processing (i.e., a reading process by interruption) whenever a start instruction to start the reading process that is executable to completion is provided during the error notification process.

When an instruction to start a process (i.e., a printing process) other than the reading process is provided during the error notification process, there is no need to interrupt the error notification process. Therefore, in such a case, the CPU 52 may perform the printing process without interrupting the error notification process. This makes it possible to suppress a decrease in the productivity of the printing process.

The MFP 1 may include a display device configured to display various types of information.

In the aforementioned illustrative embodiment, the CPU 52 performs each of the processes described above. However, the MFP 1 may include a plurality of CPUs configured to perform each of the processes described above in cooperation with each other. In this case, for instance, the image reader 2 and the printer 3 may have respective CPUS.

The image reader 2 may be a stand-alone device.

The following shows examples of associations between elements illustrated in the aforementioned illustrative embodiment(s) and modification(s), and elements claimed according to aspects of the present disclosure. For instance, the MFP 1 may be an example of a “multi-function peripheral” according to aspects of the present disclosure. The image reader 2 may be an example of an “image reader” according to aspects of the present disclosure. The printer 3 may be an example of a “printer” according to aspects of the present disclosure. The reading unit 18 may be an example of a “reading unit” according to aspects of the present disclosure. The transparent plate 14 may be an example of a “transparent plate” according to aspects of the present disclosure. The reference member 26 may be an example of a “reference member” according to aspects of the present disclosure. The CPU 52 may be included in a “controller” according to aspects of the present disclosure. Further, the memory 53 storing the programs 53a may be included in the “controller” according to aspects of the present disclosure. The CPU 52 may be an example of a “processor” according to aspects of the present disclosure. The memory 53 storing the programs 53a may be an example of a “non-transitory computer-readable storage medium” storing “computer-readable instructions” according to aspects of the present disclosure.

What is claimed is:

1. An image reader comprising:
a transparent plate having a placement surface configured to support a read target object placed thereon;
a reading unit including a light source configured to emit light toward the transparent plate; and
a controller configured to:
perform image reading to cause the reading unit to read the read target object placed on the placement surface of the transparent plate;
in response to occurrence of an error, perform an error notification process to provide a notification that the error has occurred; and
in response to receiving a start instruction to start the image reading during the error notification process, perform interrupt processing to interrupt the error notification process and start the image reading.

2. The image reader according to claim 1,
wherein the controller is further configured to:
in response to an error that prevents the image reading from being completed occurring during the image reading, perform, in the error notification process, stopping the image reading and causing the reading unit to perform an error notification operation.

3. The image reader according to claim 1,
wherein the controller is further configured to:
in the image reading, cause the reading unit to read the read target object while moving the reading unit in a first direction from a reading start position to a reading end position.

4. The image reader according to claim 3,
wherein the controller is further configured to:
in the error notification process, cause the reading unit to perform, as the error notification operation, stopping the reading unit at an error notification position.

5. The image reader according to claim 4,
wherein the error notification position is settable to different positions depending on a type of the error that has occurred, and
wherein the controller is further configured to:
in the error notification process, cause the reading unit to perform, as the error notification operation, stopping the reading unit at a corresponding one of the different positions depending on a type of the error that has occurred.

6. The image reader according to claim 4,
wherein the controller is further configured to:
stop the reading unit at a standby position that is spaced apart from the reading start position in a second direction opposite to the first direction, when the error notification process is not in progress and before the start instruction to start the image reading is received.

7. The image reader according to claim 6,
wherein the controller is further configured to:
in the interrupt processing, move the reading unit in the second direction from the error notification position to the reading start position, and start the image reading.

8. The image reader according to claim 7, further comprising:
a reference member disposed at a reference position; and
a memory,
wherein the controller is further configured to:
in response to receiving the start instruction to start the image reading when the error notification process is not in progress, move the reading unit to the reference position, cause the reading unit to read the reference member to generate image data of the reference member, obtain correction data for correcting image data of the read target object, using the image data of the reference member, and store the obtained correction data in the memory.

9. The image reader according to claim 8,
wherein the controller is further configured to:
correct the image data of the read target object using the correction data stored in the memory.

10. The image reader according to claim 1,
wherein the controller is further configured to:
after completion of the image reading started by the interrupt processing, determine whether an error state due to the error has been resolved; and
resume the error notification process in response to determining that the error state has not been resolved.

11. The image reader according to claim 1,
wherein the controller is further configured to:
perform the interrupt processing when the image reading for which the start instruction has been received is executable to completion regardless of the error.

12. The image reader according to claim 1,
wherein the controller is further configured to:
accept a setting as to whether to perform the interrupt processing; and
when a setting to not perform the interrupt processing has been accepted, continue without interrupting the error notification process even if the start instruction to start the image reading is received during the error notification process.

13. A multi-function peripheral comprising:
an image reader configured to read a read target object;
a printer configured to print an image on a printing medium; and
a controller,
wherein the image reader comprises:
a transparent plate having a placement surface configured to support the read target object placed thereon; and
a reading unit including a light source configured to emit light toward the transparent plate; and
wherein the controller is configured to:
perform an error notification process to cause the reading unit to perform an error notification operation in response to occurrence of an error that stops an operation of the multi-function peripheral; and
perform interrupt processing to start a specific process that is executable regardless of the error in response to receiving a start instruction to start the specific process during the error notification process.

14. The multi-function peripheral according to claim 13,
wherein the controller is further configured to:
perform the interrupt processing, when the operation that is stopped due to the error is an operation by one of the image reader and the printer, and the specific process that is executable regardless of the error is a process using the other of the image reader and the printer.

15. A method implementable on a processor of an image reader comprising a transparent plate and a reading unit, the method comprising:
performing image reading to cause the reading unit to read a read target object placed on a placement surface of the transparent plate;
in response to occurrence of an error, performing an error notification process to provide a notification that the error has occurred; and
in response to receiving a start instruction to start the image reading during the error notification process, performing interrupt processing to interrupt the error notification process and start the image reading.
